(19) United States
(12) Patent Application Publication
(10) Pub. No.: US 2005/0098695 A1
(43) Pub. Date: May 12, 2005

(54) Cane holder

(76) Inventor: Larry L. Hollenbeck, Canyon Country, CA (US)

Correspondence Address: LITMAN LAW OFFICES, LTD., P.O. BOX 15035 CRYSTAL CITY STATION, ARLINGTON, VA, 22215, US

(21) Appl. No.: 10/703,618

(22) Filed: Nov. 10, 2003

(51) Int. Cl. A45B 1/00; F16B 2/20

(52) U.S. Cl. 248/229.26

(57) ABSTRACT

The cane holder is a device for temporarily securing a cane or similar article to another structure. The cane holder has a pair of resilient spring clips secured to one another back-to-back by a single fastener. This allows the axes of the jaws of the two clips to be rotated relative to one another, in order to align one jaw for clipping to a structure and to align the other jaw to orient the cane clipped therein as desired. The cane holder may include one or more retaining straps for securing across either or both of the jaws, as desired. Such straps provide positive retention of a cane or the like within the clip, and/or positive retention of the holder to another structure as desired.

### BACKGROUND OF THE INVENTION

1. Field of the Invention

The present invention relates generally to small and portable clips, clamps, and similar devices, and more particularly to various embodiments of a cane holder having a double clip configuration in which the two clips are mounted back-to-back to one another. The two clips are secured together by a single permanent fastener, which allows the two clips to swivel relative to one another for different mounting environments. Various closure straps, pads, manipulating ties, etc. may be provided with the above clip assembly.

2. Description of the Related Art

Many people have some form of physical handicap which limits their mobility, and who require some form of mechanical aid or assistance for their movement. In many cases, the physical infirmity is not so severe as to require a wheelchair or similar device for mobility; many times, the handicapped person has limited use of his or her legs, and can get around reasonably well with the use of one or more crutches, canes, a walker, etc. In some instances, a person may require only a single cane, at least for some limited mobility.

Regardless of the type of aid or assistance required, the temporary storage or placement of the device has always been a problem for the physically handicapped person. In the case of a wheelchair, the person is generally seated in the chair, with the chair and the person being together at least most of the time. However, persons requiring the use of crutches or a cane often must find a location to place or store these devices while they are seated. This can even apply to persons using wheelchairs, if they have sufficient mobility to leave the chair from time to time and travel for a short distance using only a cane.

Crutches can generally be placed against a wall, table, shelf, or other upstanding structure, and are not particularly prone to slipping or falling from such placement due to their relatively flat nature. However, canes are generally constructed to have a single round, rigid structure, and the relatively small diameter and contact point of the cylindrical shape does not provide any real stability when such a cane is rested against an upstanding structure. Moreover, the carriage and transport of such a cane on or in a wheelchair, when the person requires the chair, can be cumbersome at best.

Various solutions have been attempted for the above problems in the past. Where some form of holder has been provided on a wheelchair, the articles are generally stored behind the back of the chair, where they are difficult to access by the person seated in the chair. Other devices have been developed for holding a cane or the like to the edge of a shelf or other structure, but most such devices are permanently installed.

Accordingly, a need will be seen for a holder for a cane or the like, which provides the versatility required to secure a cane to a wide variety of different structures. The holder must be configured to provide positive attachment to the cane, while being completely removable from the support structure to which it is applied. This assures that the holder will remain with the cane when the cane is moved from its resting point, rather than remaining behind where it may be forgotten. The holder must also provide sufficient versatility to adapt to removable installation upon a wheelchair, as well as to removable installation upon horizontal, vertical, and obliquely angled surfaces, while still retaining a cane at the desired orientation.

A discussion of the related art of which the present inventor is aware, and its differences and distinctions from the present invention, is provided below.

U.S. Pat. No. 4,300,742 issued on Nov. 17, 1981 to Douglas C. Hunn, titled “Cane Holder,” describes a clamp or clip assembly having one clip which secures removably to a horizontal surface, e.g. a tabletop, and another clip adapted to secure about a cane or the like. The cane attachment clip is only “slightly resilient” (column 2, line 6), and accordingly may require an adapter, depending upon the diameter of the cane. Moreover, no pivotal attachment between the tabletop clamp portion and the cane clip portion is provided; the Hunn holder cannot be used to secure a cane to other than a horizontal surface. It is also noted that Hunn does not provide any positive attachment means for insuring that his holder remains secured to the cane when the cane is removed from its supporting surface. In contrast, the pivotal mounting of the two clips of the present cane holder provides for removable attachment of the holder to a surface of any orientation, while allowing the cane to be oriented as desired. Moreover, the clips or clamps of the present holder provide much greater resiliency, to adapt to various thicknesses of mounting surfaces and cane diameters. The present cane holder also includes at least one strap to insure positive attachment of the cane to the holder, to preclude inadvertent separation of the holder from the cane.

U.S. Pat. No. 4,605,190 issued on Aug. 12, 1986 to Harry W. Kamp, titled “Cane Keeper,” describes a series of embodiments of a simple cane holder having an L-shaped supporting portion for placement upon the top and edge of a counter, tabletop, or the like. This supporting portion of the Kamp device is provided with adhesive for permanent attachment to the supporting surface. Once it has been so attached, it cannot be removed to travel with the cane. Other embodiments include various hooks and the like for temporarily securing the Kamp holder to a belt or other article of clothing, or for clipping to another structure. However, the clip is installed beneath the device and cannot be pivoted to a different orientation. Moreover, Kamp does not provide any form of positive attachment for securing his holder to the cane, to prevent separation of the device from the cane when it is temporarily secured to another structure. The pivotal attachment of the two clips and positive security of the present cane holder, are features not found in the Kamp device.

U.S. Pat. No. 4,895,330 issued on Jan. 23, 1990 to Richard F. Anstead, titled “Cane Holder,” describes a device having a plate with an opposed, spring loaded arm for gripping a tabletop or the like, with a spring clip extending therefrom for gripping a cane. The tabletop attachment portion is angularly affixed to the cane grip, and cannot be turned for mounting upon other than horizontal surfaces. Moreover, the Anstead holder cannot positively secure a cane therein; no securing strap or other positive attachment means is provided.

U.S. Pat. No. 5,381,922 issued on Jan. 17, 1995 to Neil R. Gladman et al., titled “Article Holder,” describes a belt clip and removable cup or can holder. The belt clip and cupholder have mating hook and loop fastener material thereon for removably attaching the two components together. The cupholder, with its closed bottom and closed sleeve, cannot accept an elongate article, such as a cane, from the side to extend partially around a medial portion of the article.

U.S. Pat. No. 6,000,414 issued on Dec. 14, 1999 to Jackie B. Crusor, titled “Cane Holding Apparatus And Method,” describes a two-part device comprising a belt loop or attachment, and an attachment permanently secured to a cane. The two attachments have mating hook and loop fasteners thereon for removable attachment to one another. The assembly cannot be secured to a flat horizontal, vertical, or otherwise oriented surface, as can the present cane holder, and the cane component cannot be removed from the cane once installed. No clip means of any sort is provided by Crusor in his cane holder.

U.S. Pat. No. 6,105,594 issued on Aug. 22, 2000 to Miguel Diaz, titled “Adjustable Umbrella Support Apparatus For Use With Wheel Chairs, Golf Carts, And The Like,” describes a complex assembly incorporating a receiver-type hitch extending from the rear of a motorized wheel chair, golf cart, or the like. A generally vertical umbrella pole includes a cane holder accessory, comprising a narrow elongate tube with a closed bottom. The cane holder cannot be attached to a tabletop or other similar surface, and there is no means for positively securing a cane to the cane holder or for changing the angle of the cane holder, as provided by the present invention.

U.S. Pat. No. 6,311,942 issued on Nov. 6, 2001 to Leah Rotter et al., titled “Bedside Cane Holder,” describes a generally rectangular frame which is placed between the mattress and box spring of a bed. The frame includes a clamp at one corner, for removably holding a cane. The clamp comprises two semicylindrical portions, with one being fixed and the other being hinged to the frame. The cane is placed between the two portions, and a locking sleeve, which is permanently secured around the cane, is dropped into place about the upper portions of the two clamp portions to secure them about the cane. This assembly cannot provide for rotation of the cane relative to the remaining structure, nor can the assembly provide for securing the cane removably to a tabletop or other flat horizontal, vertical, or oblique surface, nor can it provide for the removable attachment of a cane to a wheelchair, as can the present cane holder invention.

U.S. Pat. No. 6,520,194 issued on Feb. 18, 2003 to John K. Frazier, titled “Holder For Canes, Umbrellas And The Like,” describes a rubberized sleeve having a closed end, for removably installing on the handle end of a cane, umbrella, or similar device. The closed end of the sleeve includes some form of enhanced grip, i.e. a tread-like pattern. The closed end of the device is in contact with a tabletop or the like, when the handle end of the cane is hooked over the edge of the tabletop. No positive attachment of the device to the tabletop or other structure is provided by Frazier.

U.S. Pat. No. 6,547,112 issued on Apr. 15, 2003 to Charles E. Gallagher et al., titled “Crutch And Cane Holder System,” describes a series of sleeves which are adjustably and essentially permanently attached to the back of a motorized wheelchair or scooter. The ends of the crutches or cane(s) are placed in the sleeves, with the underlying platform serving as a stop for articles placed in the sleeves. The Gallagher et al. device cannot be removably attached to a tabletop or other flat, planar surface to secure a cane temporarily and removably thereto, as can the present invention.

U.S. Pat. No. 6,565,053 issued on May 20, 2003 to Joshua Larky, titled “Cane Holder,” describes a series of embodiments of a clamp for removably securing a cane to a wheelchair or other tubular structure. Most of the embodiments are directed to a roller cam type clamp configuration. However, the embodiment of FIG. 6B illustrates a pair of opposed spring clamps. The clamps of the Larky cane holder cannot be secured to a planar surface, e.g. tabletop, shelf or side panel, etc., as is clearly stated by Larky in the first line of the abstract. Moreover, Larky does not disclose any means of positively locking his holder either to a cane or to the structure to which his holder is secured. The present cane holder may be secured to any suitable planar or non-planar object, and may be positively locked in place upon any non-planar (i.e., round or tubular) object to which it is secured by means of a surrounding strap which may be secured about the object, and may also provide for such positive locking of a cane or the like therein using essentially the same surrounding strap configuration.

U.S. Pat. No. 6,601,865 issued on Aug. 5, 2003 to Sebert Harper, titled “Visually Appealing Versatile Rollable And Foldable Chair,” describes a complex wheeled chair having a large number of features and accessories thereon. Among the accessories is a cane holder comprising a lower socket or receptacle and an upper clip. The cane holder is permanently affixed to the chair, and cannot be removed to secure the cane removably to some other object, as can the present cane holder.

U.S. Patent Publication No. 2002/134,808 published on Sep. 26, 2002, titled “Crutch And Cane Holder System,” is the earlier publication of the issued '112 U.S. patent to the same patentees discussed further above. The same differences between the Gallagher et al. device and the present invention noted in that earlier discussion, are seen to apply here as well.

Japanese Patent Publication No. 2001-340,164, published on Dec. 11, 2001, describes (according to the drawings and English abstract) a device requiring permanent modification to the chair for the installation of an attachment for removably securing the device to the chair. A generally vertical strap is attached to the back of the chair, with the strap having a lower receptacle or socket and a closed upper sleeve. The cane must be lifted completely clear of the upper sleeve for removal or placement of the cane from or into the holder. The device cannot be swiveled to provide different orientations between an attachment bracket and the cane, as provided by the dual clips or clamps of the present invention.

Finally, Japanese Patent Publication No. 2002-65,444, published on Mar. 5, 2002, describes (according to the drawings and English abstract) an L-shaped bracket which may be placed over the upper surface and along the edge of a tabletop or the like. The depending portion of the bracket includes a pair of protuberances, between which a cane may be rested. No means of positively attaching the device to the cane is provided, to prevent the loss of the device. The cane holder of the '444 Japanese Patent Publication more closely resembles the device of the '190 U.S. patent to Kamp, discussed further above, than it does the present invention.

None of the above inventions and patents, taken either singly or in combination, is seen to describe the instant invention as claimed. Thus a cane holder solving the aforementioned problems is desired.

### SUMMARY OF THE INVENTION

The present invention comprises various embodiments of a cane holder, each incorporating a pair of clamps or clips secured together back-to-back by a single fastener. The single fastener allows the two clips to swivel relative to one another, so that the axes of their jaws may be adjusted to or from a parallel relationship to one another, as desired. At least one of the clips is provided with a securing strap which wraps around the outside of the two jaws or sides of the clip, to secure an object positively therein. Hook and loop fastening material is preferably used for the securing strap. Alternatively, both clips may be provided with such a securing strap, if so desired.

Two of the present cane holders may be secured to a wheelchair, with one clip installed on each of the vertical tubes supporting the forward ends of the armrests. The hook and loop or other securing straps are secured about the respective vertical members, and the other clips are swiveled to align their jaw axes to be concentric with one another. A cane may then be clipped into the two concentric jaws across the front of the wheelchair and across the lap of a person seated in the chair, where it is readily accessible by the person. The positive attachment of the clips to the chair structure ensures that the clips will remain on the chair when the cane is removed. Alternatively, the straps may be secured about the cane, to ensure that the clips will remain with the cane when it is removed from the chair, if so desired.

The above-described configuration is also well suited to temporarily secure a cane to the edge of a tabletop, a shelf, a shelf upright, etc. The open clip may be secured to the edge of the flat, planar surface, with the opposite clip secured to the cane with the securing strap wrapped about the cane. This ensures that the cane holder will remain with the cane, and will not be inadvertently left behind when the cane is removed for use. The swivel attachment of the clips to one another assures that the cane will have the orientation desired, regardless of the orientation of the panel to which the holder is attached.

Another alternative embodiment provides a securing strap for both clips. Such an embodiment may include different sized clips, if so desired. The larger or smaller clip may be secured to the edge of a panel, depending upon the thickness of the panel. The securing strap for the panel attachment clip remains open in such an application. The opposite clip is used to secure the cane therein, with any looseness due to the larger clip being compensated by the surrounding securing strap which assures that the cane cannot fall from the clip.

The securing straps used with the present cane holder may comprise any of a number of embodiments. One embodiment utilizes double sided hook and loop fastener straps, where the hook and loop material is secured to the outside of the clip and the strap wraps over the mouth of the clip to secure to itself on the opposite side. Another embodiment utilizes a buckle principle, where the strap passes through the buckle on the opposite side and secures back to itself. Other configurations may be used as desired.

Accordingly, it is a principal object of the invention to provide a versatile and adaptable holding device for temporarily securing canes and other relatively thin, elongate objects to another structure.

It is another object of the invention to provide a cane holder having a pair of clips, which may have either identical or different sizes, secured to one another back-to-back by a single fastener, allowing the two clips to pivot relative to one another so that the axes of their jaws may be aligned as desired.

It is a further object of the invention to provide a cane holder having at least one positive retaining strap that can be secured across the mouth of at least one of the clips in order to secure an object positively within the clip.

Still another object of the invention is to provide a cane holder having a pair of clips and a positive retaining strap for one or both of the clips, with the retaining strap selected from various types of hook and loop fastening material and extending across the clip jaw to adhere to its opposite end, or to pass through a loop to double back in order to adhere to itself.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a pair of the cane holders of the present invention, removably securing a cane across the front of a wheelchair.

FIG. 2 is an exploded perspective view of the cane holder assembly of FIG. 1, showing various details thereof.

FIG. 3 is an environmental perspective view of an alternative embodiment of the present cane holder, wherein the holder has a single retaining strap and is removably clipped to the edge of an upright panel.

FIG. 4 is an environmental perspective view of the cane holder embodiment of FIGS. 1 and 2, showing its removable attachment to the edge of a generally horizontal panel.

FIG. 5 is an environmental perspective view of yet another embodiment of the present cane holder, wherein one retaining strap passes through a loop to double back upon itself.

Similar reference characters denote corresponding features consistently throughout the attached drawings.

### DETAILED DESCRIPTION OF THE PREFERRED EMBODIMENTS

The present invention comprises a series of embodiments of a cane holder for temporarily securing a cane (or similar relatively thin, elongate object) to another structure. The present cane holder is quite versatile and adaptable, and may be used to secure a cane or similar object to such structures as wheelchairs, the edges of tabletops, shelves, etc., as desired.

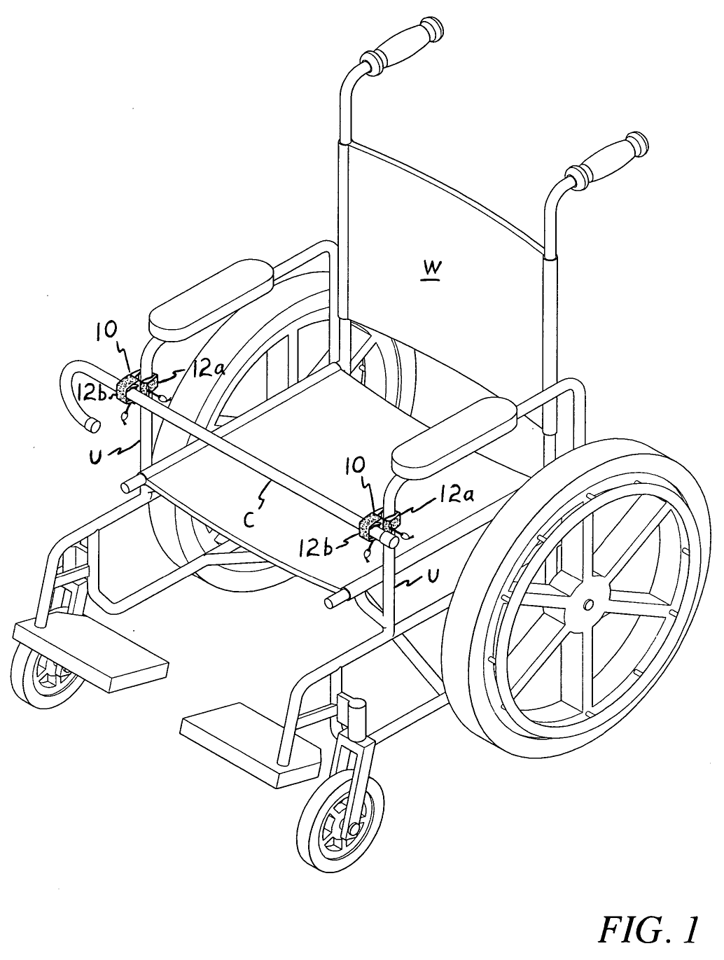

FIG. 1 of the drawings provides an illustration showing the removable installation of a pair of first embodiment holders 10 of the present invention on a conventional wheelchair W, and removably holding a cane C across the wheelchair W. The holders 10 essentially comprise a pair of clips secured together in a back-to-back relationship, so that one of the clips is secured to the wheelchair structure, e.g. an arm support upright U, and the attached clip is used to secure the cane C. A pair of such holders 10, with one holder 10 on each upright U, serves to hold the cane C securely across the front of the wheelchair W and across the lap or knees of a person seated in the wheelchair W, where it is readily accessible by the person when he or she requires use of the cane C. Other environments of use for the cane holder 10, or other embodiments thereof, are illustrated in the other drawings.

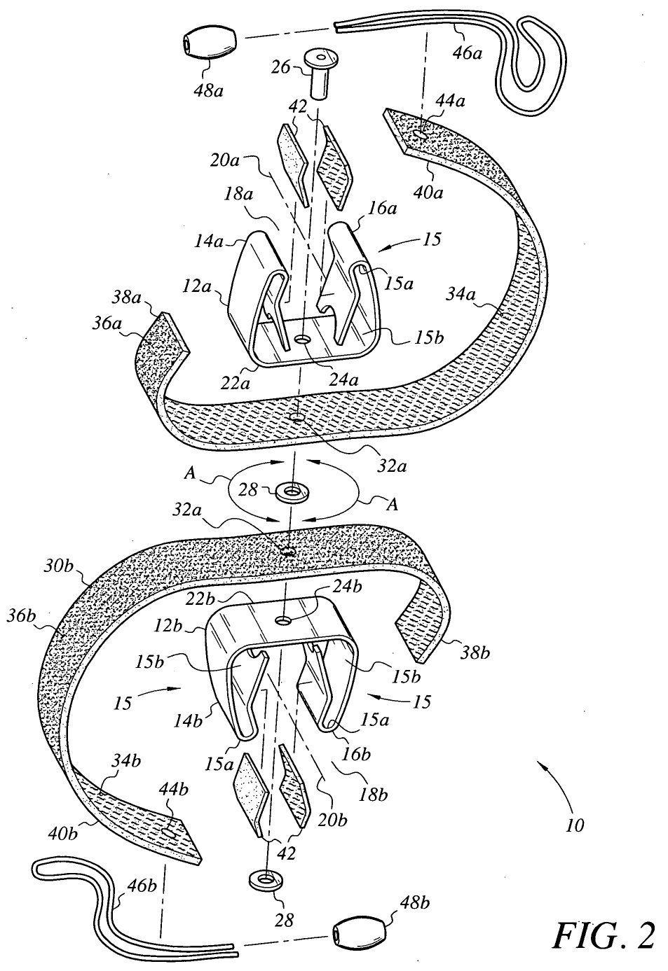

FIG. 2 provides an exploded perspective view of the cane holder 10, showing the various details of its construction. The holder 10 essentially comprises a first clip 12a and a second clip 12b, as noted above. The two clips 12a and 12b are preferably formed of a wide, thin band of resilient material (e.g. spring steel, or even some plastics), bent from flat stock in the case of spring steel, or perhaps cast or otherwise formed in the case of plastics. In the case of clips formed of spring steel, a protective finish (e.g., powder coating or other protective coating, as desired) may be applied to the two clips 12a and 12b in order to preclude corrosion of the spring steel material.

Each of the two clips 12a and 12b includes a first jaw, respectively 14a and 14b, and an opposite second jaw, respectively 16a and 16b. The jaws of each clip respectively define a first clip jaw opening 18a for the first clip 12a and second clip jaw opening 18b for the second clip 12b. Each of the jaw openings further defines a clamping axis, respectively 20a and 20b for the two clips 12a and 12b, normal to the span of the jaw openings 18a and 18b of the two clips 12a and 12b. An elongate article (cane C, wheelchair armrest upright tube U, etc.) clipped within either of the two clips 12a or 12b, will have its major axis aligned with the clamping axis 20a or 20b of its respective clip 12a or 12b. In a similar manner, a flat, planar surface (tabletop, shelf, etc.) to which either of the clips 12a or 12b is secured, will have its major span or dimension aligned with the respective axis 20a or 20b as well.

Accordingly, the two clips 12a and 12b may be swiveled relative to one another, to align their respective clamping axes 20a and 20b as required. Each of the clips 12a and 12b includes a back portion, respectively 22a and 22b, behind or opposite their respective jaws 14a, 16a and 14b, 16b and their jaw openings 18a, 18b. Each of the clip backs 22a and 22b has a fastener hole, respectively 24a and 24b, formed centrally therethrough. A single fastener 26 (e.g., rivet, bolt and nut, etc.) passes through the two holes 24a and 24b to secure the two clips 12a and 12b together in a back-to-back arrangement, with the two clips swiveling about the fastener 26. Washers 28 may be installed as required or desired.

This arrangement permits the two clamping axes 20a and 20b to be aligned relative to one another, as desired. In FIG. 2, the two axes 20a and 20b are essentially parallel to one another, with an object clipped within one clip, being aligned essentially parallel to the major axis of the structure to which the opposite clip is secured. However, FIG. 1 demonstrates the alignment of the two clips 12a and 12b with their axes 20a and 20b essentially perpendicular to one another. In FIG. 1, the two first clips 12a are clipped to the essentially vertical uprights U of the two wheelchair arms, with their jaw axes 20a oriented accordingly. However, the cane C is oriented generally horizontally across the front of the wheelchair W, with the jaw axes 20b of the second clips 12b having the same orientation in order to hold the cane C. The versatility provided by the swiveling of the two clips 12a and 12b, as shown by the swivel motion arrows A in FIG. 2, allows an object to be temporarily secured to virtually any tubular or flat, planar structure as desired, regardless of the orientation of the supporting structure or object secured.

The two clips 12a and 12b may be of any practicable size or dimensions, as desired. It may be desirable to have identically sized clips, in many instances. However, it may be desirable to make one of the clips larger than the other, in order for the larger clip to fit over relatively thick panel edges, e.g. tabletops and the like. The smaller clip may always be used on a thinner surface and the cane C contained within the larger clip, if necessary, if some means is provided for positively securing the cane C or other object within the larger clip.

Accordingly, the present cane holder also includes such means for positively holding or securing the cane within one of the clips to prevent the cane from inadvertently falling from the clip(s), and/or positively securing the holder to another structure to preclude its inadvertent separation therefrom. Preferably, at least one of the two clips is provided with such positive retaining means. In the cane holder embodiment 10 of FIGS. 1, 2, and 4, each of the clips 12a and 12b include a retaining strap, respectively 30a and 30b, extending therefrom. The retaining straps 30a and 30b are preferably formed of cooperating hook and loop fabric fastener material (e.g., Velcro®), but other materials, e.g. cooperating snaps, etc., may be used as desired.

The retaining straps 30a and 30b may be secured to their respective clips 12a and 12b using any suitable means, e.g. adhesives, etc. A particularly good way of anchoring the two straps 30a and 30b to their respective clips 12a and 12b is by forming holes 32a through the clip attachment areas of the straps, and securing them in back-to-back fashion using the same rivet 26 or other fastener used to secure the two clips 12a and 12b together. The friction provided between the two straps 30a and 30b, provides positive positioning for the two clips 12a and 12b when they are swiveled relative to one another, so the clips 12a and 12b will hold their respective positions once adjusted. Adhesive or other suitable conventional attachment means is also preferably used to secure the two straps 30a and 30b to their respective clips 12a and 12b.

The retaining straps 30a and 30b are preferably double sided, i.e. provided with hook material 34a, 34b on one surface and cooperating loop material 36a, 36b on the opposite surface. Thus, when the attachment or anchor ends 38a, 38b of the straps 30a, 30b are secured to their first jaw sides 14a, 14b with their second or loop material 36a, 36b facing outwardly, the opposite extension ends 40a, 40b of the straps may be wrapped around and over the jaw openings 18a, 18b of the clips 12a, 12b to positively close the openings 18a, 18b, and are secured with their inwardly facing first or hook surface material 34a, 34b contacting the loop material 36a, 36b of the opposite anchor ends 38a, 38b of the straps 30a, 30b. This provides for the positive retention of an object within the clip(s) 12a and/or 12b, and/or means for positively securing the holder 10 to another structure as desired. Additional material of the same type, or some other resilient material, may be applied to the inner surfaces of the jaws 14a, 16a and 14b, 16b to serve as pads 42, to avoid marring the surface of an object or article to which the holder is applied.

It can be difficult to disengage the end of a completely applied strip of hook and loop material. Accordingly, the present holder provides means to facilitate such removal. Each of the extension ends 40a and 40b of the two retaining straps 30a and 30b is provided with a thong attachment hole, respectively 44a and 44b, through which a manipulating thong, respectively 46a and 46b, is passed. The thongs may comprise a length of suede cord or lace material, or other material as desired. The thongs 46a, 46b may be doubled, with the doubled ends passed through the respective holes 44a, 44b and the doubled cord passed through the loop, in the manner of a girth hitch. Other means of attaching the thongs or cords 46a, 46b may be used as desired. One or more bead handles 48a, 48b may be strung on each of the thongs 46a, 46b, with the ends of the thongs knotted together to secure the beads 48a, 48b in place.

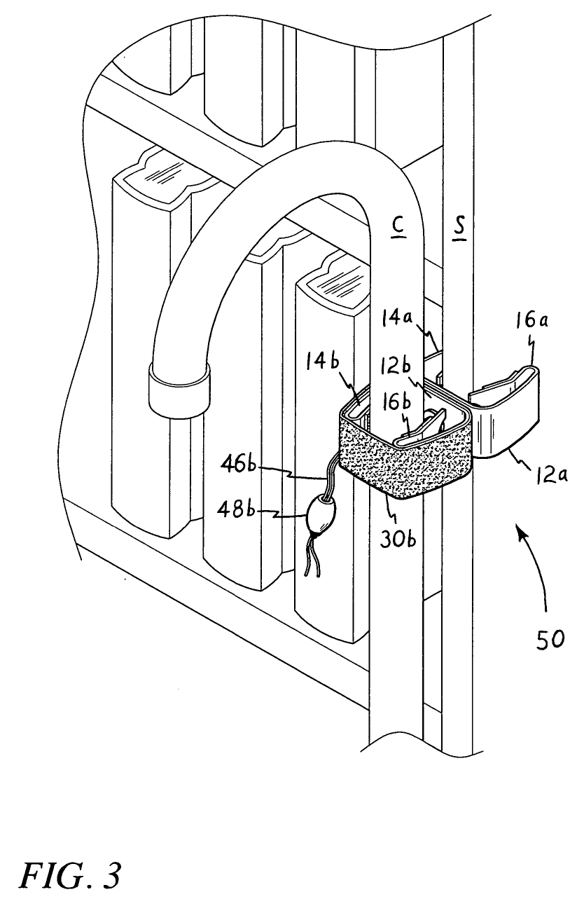

FIG. 3 of the drawings provides an environmental perspective view of a second embodiment of the present cane holder, designated as holder 50. The holder 50 of FIG. 3 is quite similar to the holder 10 of FIGS. 1, 2, and 4, with the exception of the first retaining strap and its various features, which are omitted from the holder 50. Otherwise, the holder 50 of FIG. 3 possesses all of the various features of the holder 10 of FIGS. 1, 2, and 4, including first and second clips 12a, 12b with each having a first jaw 14a, 14b and an opposite second jaw 16a, 16b. The second clip 12b includes the second clip retaining strap 30b, shown wrapped around the jaws 14b, 16b to secure a cane C positively therein. Release of the cane C is easily accomplished by grasping the bead handle 48b on the thong 46b, and pulling the extended end of the second retaining strap 30b away from its anchor end to open the second clip 12b for removal of the cane C therefrom. The first retaining strap is not needed in the environment of use of the holder 50 of FIG. 3, as the first clip 12a is removably secured to the edge of a relatively wide vertical shelf member S. The first retaining strap is thus not needed in such an application.

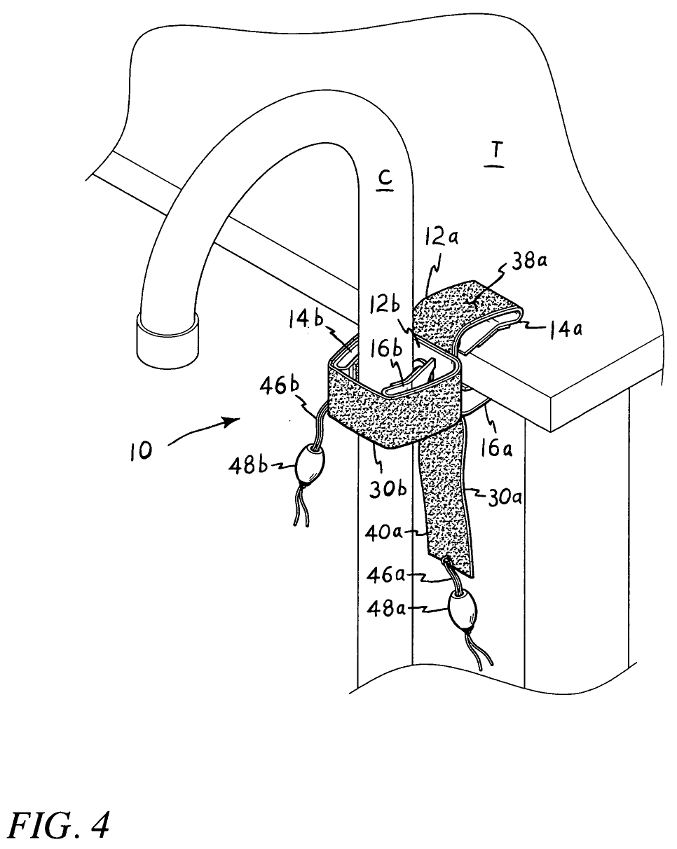

However, it will be seen that the holder 10 with its two retaining straps 30a and 30b may be applied to the edge of such a relatively wide object if desired, merely by opening the first retaining strap to allow the two jaws to grasp the edge of the object. FIG. 4 illustrates such an application of the first embodiment holder 10, with the holder 10 shown secured to the edge of a tabletop T. The holder 10 of FIG. 4 is of course essentially identical to the holders 10 shown in FIG. 1 and in the exploded view of FIG. 2. However, in order to allow the first clip 12a to be secured to the edge of the tabletop T (or to a similar structure, as desired), the first retaining strap 30a has been released from its respective anchor end 38a to open the two first jaws 14a and 14b, to allow them to be clipped to the edge of the tabletop T. The remaining second clip 12b is used to secure the cane C therein, with the second retaining strap 30b secured about the jaws 14b and 16b to secure the cane C therein.

It will be noted that the cane holder 10 of FIG. 3 has been adjusted so its two clips 12a and 12b are turned with their axes essentially normal to one another, in order to allow the cane C to be held generally vertically while the first clip 12a is secured to a horizontal surface. The swiveling or pivoting action of the two clips 12a and 12b relative to one another provide the versatility for attachment to a horizontal surface, as shown in FIG. 4, or to a vertical surface, as shown in the holder 10 of FIG. 3, or to any angle between, while holding the cane C or other article vertically or at some other angle as desired.

The two clips 12a and 12b may be identical in size, or one may be larger than the other, as desired. Preferably, at least one clip has a jaw width which closely fits about the cane C or other article normally secured therein, with the other clip being of the same size or perhaps slightly larger. This permits the larger clip to be secured to somewhat thicker structures, but where the device must be used on a thinner structure, the holder may be reversed with the smaller clip used for attachment to the thinner structure. The cane C will still be positively secured within the larger clip, merely by wrapping the retaining strap across the jaws to secure the cane C therein, as shown in FIGS. 3 and 4.

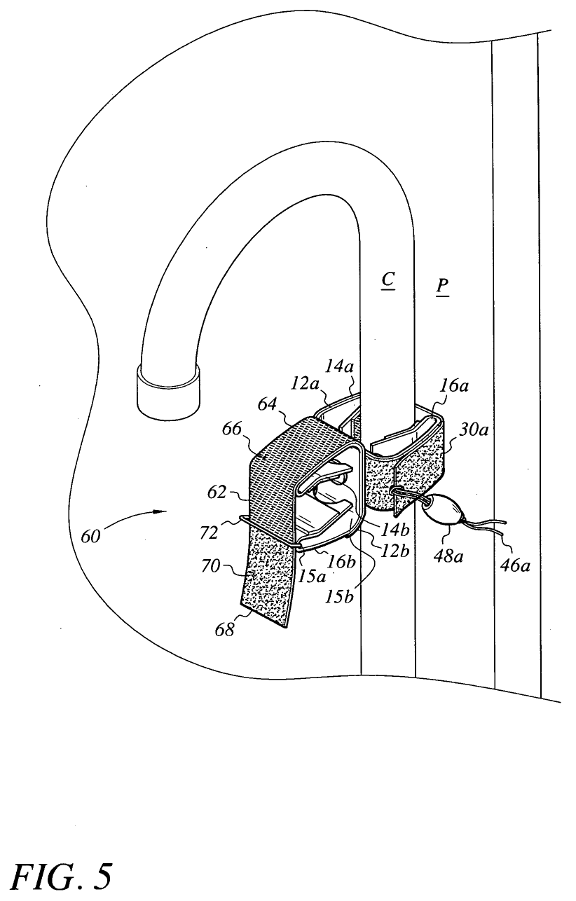

FIG. 5 illustrates still another embodiment of the present cane holder, designated as holder 60. The holder 60 is also constructed using two clips 12a and 12b, with their respective jaws 14a, 16a and 14b, 16b. The first clip 12a includes a first retaining strap 30a with its manipulating thong 46a and bead 48a, as well as all of the other features illustrated for the first clip 12a in the exploded view of FIG. 2. The second clip 12b and the means of fastening the two clips 12a and 12b of FIG. 5 together are also identical to the assembly shown in FIG. 2.

The holder 60 differs from the holders 10 and 50 in the configuration of the second retaining strap 62 of the second clip 12b. Rather than using a double sided hook and loop material, as is used for the first and second straps 30a and 30b of the holder 10, the second strap 62 of the holder 60 comprises a proximal end or portion 64 secured to the first jaw 14a of the second clip 12b, having hook material 66 disposed over the outer or attachment surface thereof. The distal end portion 68 includes loop fastener material 70 disposed over the same surface of the strap 62 as hook material 66. A loop or bail 72 extends from the end of the second jaw 16b of the second clip 12b, to serve as the strap anchor. The second strap 62 is secured across the two jaws 14b and 16b by passing the distal end 68 through the loop 72 extending from the second jaw 16b, and doubling the strap 62 back over upon itself so the loop material 70 of the distal end 68 engages the facing hook material 66 of the proximal end portion 64 of the second strap 62. The passage of the strap 62 through the loop or bail 72 provides additional leverage for pulling the strap 62 tautly across the two jaws 14b, 16b, thereby providing additional security for any article secured therein. The distal end portion 68 of the second strap 62 may be provided with a tab or the like which is free of the hook and loop fastener material in order to facilitate grasping the end 68 for release when desired, as the thong and bead release components of other straps cannot pass through the anchor loop or bail 72 of the second jaw 14b of the second clip 12b in the holder 60 of FIG. 5.

It will be noted that the environment of use of the holder 60 embodiment of FIG. 5 is somewhat different from that illustrated in other drawings and described further above. In FIG. 5, the holder 60 is shown supporting a cane C which is leaning against a wall panel P or the like. It will be noted that the handle of the cane C is oriented outwardly from the panel P surface, rather than resting against the panel P surface, as would be the case where no holder is used. The outward orientation of the cane C handle is due to the relatively flat resting surface defined by the space across the two clip jaws 14a and 16a, along with the flat span of the retaining strap 30a extending thereacross, which reduces the tendency for the holder 60 to roll toward one side or the other. The grip of the two jaws 14a and 16a on the shaft of the cane C holds the cane C securely in whatever orientation it has been placed. Thus, a person using the cane C and any of the embodiments of the present holder may rotate the cane C within the holder to orient the handle portion away from the wall panel P, where the cane C handle is much easier to grip when needed.

The environment of use illustrated in FIG. 5 shows the cane C being gripped by the same clip 12a as is resting against the wall panel P, with the opposite clip 12b being empty. It will be seen that the second clip 12b could be rotated to orient its grip axis essentially vertically, as in the holder 50 of FIG. 3, and the cane C could be placed within the second clip 12b to position the cane C farther from the wall panel P, if so desired. The versatility of the present cane holders in their various embodiments provides significant freedom of choice in the mode of use of the device.

In conclusion, the present cane holder invention provides a much needed means for a physically handicapped person requiring at least periodic use of a cane, to hold the cane when not being used where it will be ready for use when desired. The present cane holder is readily adaptable for use in securing a cane or the like across a wheelchair, to an upstanding or horizontal shelf or tabletop, a pole lamp or the like, or to any other suitable structure. The provision of securing straps for one or both of the clips of the device provides further versatility in the installation of the holder to another structure, and/or in securing a cane to the holder. In one example, it may be desirable to secure one or more of the holders to another structure using the securing straps, as in the attachment of the holders to a wheelchair. The holders will thus remain with the wheelchair when the cane is removed from the holders. In other instances, it may be desirable to secure the holder(s) to the cane by means of the securing straps. In this manner, when the cane is temporarily secured to the edge of a tabletop, bookshelf, or the like when the user visits a restaurant, library, or other facility, he or she is assured that the holder will remain with the cane, rather than remaining clipped to the supporting structure and being inadvertently left behind when the user takes the cane upon departure. Accordingly, the present cane holder in any of its various embodiments will be recognized as a most useful accessory by anyone who has need of a cane from time to time, or any other elongate article which might be secured to another structure by means of the present holder.

It is to be understood that the present invention is not limited to the embodiments described above, but encompasses any and all embodiments within the scope of the following claims.

1. A cane holder, comprising:
a first clip and a second clip, each of the clips being formed of a wide, thin band of resilient material having a first jaw and a second jaw defining a jaw opening therebetween, each said jaw having a U-shape, and a back portion extending thereacross between each said first jaw and said second jaw, each of the back portions having a centrally disposed fastener hole defined therethrough;
wherein the jaw opening is defined between the apexes of the first and second U-shaped jaws of each said first clip and said second clip;
a single fastener disposed through the fastener hole of each of the clips, pivotally securing the clips together in a back-to-back orientation; and
at least one retaining strap assembly selectively extending and closing across the jaw opening of at least said first clip.

2. The cane holder according to claim 1, further including another retaining strap assembly selectively extending and closing across the jaw opening of said second clip.

3. The cane holder according to claim 2, wherein each said at least one retaining strap assembly comprises:
a strap anchor secured to said first jaw; and
a strap extension extending from said second jaw.

4. The cane holder according to claim 3, further including a manipulating thong extending from said strap extension.

5. The cane holder according to claim 3, wherein:
each said strap extension further includes first hook and loop fastener material thereon; and
each said strap anchor further includes second hook and loop fastener material thereon.

6. The cane holder according to claim 1, wherein:
said strap extension has a proximal portion formed of first hook and loop fastener material, and a distal portion formed of second hook and loop fastener material capable of mating with the first hook and loop fastener material; and
said strap anchor further comprises a loop extending from the apex of said second jaw.

7. The cane holder according to claim 1, wherein each said clip is formed of material selected from the group consisting of spring steel and plastic.

8. A cane holder, comprising:
a first clip having a first pair of U-shaped jaws, each jaw having an apex defining a first jaw opening between the apexes thereof;
a second clip, having a second pair of U-shaped jaws, each jaw having an apex, secured to said first clip and defining a second jaw opening between the apexes thereof; and
at least one retaining strap assembly selectively extending and closing across at least the first jaw opening.

9. The cane holder according to claim 8, wherein each said clip is formed of a wide, thin band of resilient material, each said first jaw pair and a said second jaw pair defining said jaw opening therebetween, a back portion extending thereacross behind each said respective jaw, with each said back portion having a centrally disposed fastener hole therethrough; the cane holder further comprising:
a single fastener installed through the fastener hole of each said clip, pivotally securing each said clip together in a back-to-back orientation; and
wherein said at least one retaining strap assembly comprises a strap anchor secured to said first jaw and a strap extension extending from said second jaw.

10. The cane holder according to claim 9, further including a manipulating thong extending from said strap extension.

11. The cane holder according to claim 9, wherein:
said strap extension further includes first hook and loop fastener material disposed thereon; and
said strap anchor further includes second hook and loop fastener material disposed thereon.

12. The cane holder according to claim 8, said at least one retaining strap assembly comprises a strap anchor and a strap extension, wherein:
said strap extension has a proximal portion formed of first hook and loop fastener material, and a distal portion formed of second hook and loop fastener material; and
said strap anchor further comprises a loop extending from the apex of said second U-shaped jaw.

13. The cane holder according to claim 8, wherein each said clip is formed of material selected from the group consisting of spring steel and plastic.

14. A cane holder, comprising:
a first clip and a second clip, each of the clips being formed of a wide, thin band of resilient material having a first jaw and a second jaw defining a jaw opening therebetween, each said first jaw and said second jaw having a U-shape defining an apex, and a back portion extending thereacross between each of the respective jaws opposite the apexes thereof, the back portions each having a centrally disposed fastener hole defined therethrough;
a single fastener disposed through the fastener hole of each of the clips, pivotally securing the clips together in a back-to-back orientation; and
at least one retaining strap assembly selectively extending and closing across the jaw opening of at least the first clip.

15. The cane holder according to claim 14, wherein said at least one retaining strap assembly comprises:
a strap anchor secured to said first jaw; and
a strap extension extending from said second jaw.

16. The cane holder according to claim 15, further including a manipulating thong extending from said strap extension.

17. The cane holder according to claim 15, wherein:
said strap extension further includes first hook and loop fastener material disposed thereon; and
said strap anchor further includes second hook and loop fastener material disposed thereon.

18. The cane holder according to claim 14, said at least one retaining strap assembly comprises a strap anchor and a strap extension, wherein:
said strap extension has a proximal portion formed of first hook and loop fastener material, and a distal portion formed of second hook and loop fastener material; and
said strap anchor further comprises a loop extending from the apex of said second jaw.

19. The cane holder according to claim 14, wherein each said clip is formed of material selected from the group consisting of spring steel and plastic.
